(19) United States
(12) Patent Application Publication
(10) Pub. No.: US 2008/0235265 A1
(43) Pub. Date: Sep. 25, 2008

(54) SYSTEM AND METHOD FOR A STENOGRAPHIC SHARING NETWORK

(76) Inventor: Melissa H. Hirsch, Los Angeles, CA (US)

Correspondence Address: PERKINS COIE LLP, P.O. BOX 1208, SEATTLE, WA, 98111-1208, US

(21) Appl. No.: 12/051,800

(22) Filed: Mar. 19, 2008

Related U.S. Application Data
(60) Provisional application No. 60/919,405, filed on Mar. 21, 2007.

(51) Int. Cl. G06F 17/30; G06F 3/048

(52) U.S. Cl. 707/102; 715/753; 707/E17.044

(57) ABSTRACT

A method and system provide a stenographic sharing network. The system includes a network. The system includes a server in communication with at least one user over the network, the user associated with a user role selected from the set consisting of: a court reporting agency, a court reporter, and a law firm. The server is configured to provide a user interface to a job sharing network to the user. The server is configured to, responsive to user invitations and acceptances, build a user network of affiliates. The server is configured to display a user calendar of jobs, the user calendar dependant on the user's role and accepted jobs.

### CROSS REFERENCE TO RELATED APPLICATIONS

This application claims priority to provisional application No. 60/919,405 entitled “SYSTEM AND METHOD FOR A STENOGRAPHIC SHARING NETWORK”, filed Mar. 21, 2007, and which is incorporated herein by reference.

### BACKGROUND

The foregoing examples of the related art and limitations related therewith are intended to be illustrative and not exclusive. Other limitations of the related art will become apparent to those of skill in the art upon a reading of the specification and a study of the drawings.

When a stenographer is required, a potential employer may contact a known court reporting agency to fill the position. However, most agencies are small and have limited geographic coverage. If the contacted agency is unable to fill the requested position the agency may offer the job to another agency in the area, most likely one known through personal contacts. The contacted agency must call other known agencies until they are able to find one that is able to fill the position. The process of locating an agency to fill the position can be time consuming and burdensome.

Alternatively, an employer may contact a headhunter by phone who, for a fee, will find a stenographer to fill the position. The headhunter will call their contacts until they are able to fill the position. Calling each individual agency takes time and effort.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A system and method which allows affiliated agencies to share jobs across geographic regions is disclosed herein. The system and method provide a robust and efficient technique for communicating a variety of information, particularly with respect to the stenographic industry.

These and other advantages of the present invention will become apparent to those skilled in the art upon a reading of the following descriptions and a study of the several figures of the drawings

### BRIEF DESCRIPTION OF THE DRAWINGS

FIG. 1 depicts an example flowchart of the use of a job sharing network.

9 FIG. 2 depicts an example flowchart of an agency building an affiliate network.

FIG. 3 depicts an example flowchart of posting a job for other agencies.

FIG. 4 depicts an example flowchart of accepting a job offered by an affiliate agency.

FIG. 5 depicts an example court reporting agency network.

FIG. 6 depicts an example law firm—court reporting agency network.

FIG. 7 depicts an example court reporter—court reporting agency network.

FIG. 8A depicts an example profile creation screen shot in the stenographic sharing network.

FIG. 8A depicts an example profile creation screen shot in the stenographic sharing network.

FIG. 8B depicts an example invitation screen shot in the stenographic sharing network.

FIG. 8C depicts an example invitation acceptance screen shot in the stenographic sharing network.

FIG. 8D depicts an example affiliate network screen shot in the stenographic sharing network.

FIG. 8E depicts an example job posting submission screen shot in the stenographic sharing network.

FIG. 8F depicts an example user calendar screen shot in the stenographic sharing network.

FIG. 8G depicts an example job acceptance screen shot in the stenographic sharing network.

### DETAILED DESCRIPTION

A method and system are provided to facilitate job sharing within a stenographic network. Agencies may view all pending jobs within their affiliate network and post jobs to all affiliate reporters. This improves revenue and reduces last minute jobs.

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

Embodiments of the inventions are illustrated in the figures. However, the embodiments and figures are illustrative rather than limiting; they provide examples of the invention.

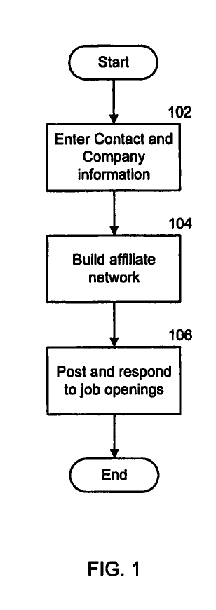

FIG. 1 depicts and example flowchart 100 of the use of a job sharing network. The flowchart 100 include block 102, block 104, and block 106.

Block 102 represents a user inputting the contact and company information into a job sharing network. In some example embodiments, inputting the contact and company information may be accomplished by the user logging into a website and using a user interface provided by the website. The interface may be graphical or text based. In some alternative embodiments, the user may input the information through a client running locally on the user's computer. The client may then upload the information to the network.

Contact information may include one or more user's names, one or more email addresses, one or more addresses, one or more phones numbers, or any other contact information which may be known or convenient. Company information may include the name of the company, the area the company is located, number of offices, billing information, or any other information related to the company which is known or convenient. In some example embodiments, the user may select some of the attributes to be hidden from others in the network, such as billing information and email addresses.

Block 104 represents a user building an affiliate network. In some example embodiments, a search function is included which allows the user to search for other users on the system. The user may send requests to be added to the affiliate network of the other users on the network. When the user requests to be added to the affiliate network of other users the other users may receive an email indicating the user has asked to be added to the other user's affiliate network. In some example embodiments, the other user may opt out of receiving emails and will only be notified through a message system on the network. In some example embodiments, the other user may accept the invitation, decline or ask for more information. If more information is requested the other user may fill out a form indicating what additional information they require. In other embodiments, the user may enter a text message to the user indicating what additional information they would like to receive before adding them to the affiliate network.

Block 106 represents posting and responding to jobs in the system. In some example embodiments, the company of the user will have a calendar showing which jobs they have, which jobs they have posted as open, and which jobs those in their affiliate network have posted as available. In some example embodiments, the type of a job will be indicated by the color the job appears on the calendar. For example, jobs offered to others in the affiliate network may be blue, while jobs accepted may be red. In some embodiments, the status of a job will be indicated by a keyword, indicating if the job is opened, filled, etc. The calendar may be in any form known or convenient, and may be customizable to show multiple spans of time, such as days, weeks, months or years.

FIG. 2 depicts and example flowchart 200 of an agency building an affiliate network. The flowchart 200 includes block 202, block 204, block 206, decisional node 208, and block 210.

Block 202 depicts a first agency with a registered account searching for a second agency on a web based job posting system. In some example embodiments, the name of the second agency or an employee at the agency must be known. In other example embodiments, a second agency may be searched for on any number of criteria, such as size, geographic location, billing rates, etc. In some example embodiments, the first agency must log-in to a website system using a name and password as validation.

Block 204 depicts the first agency inviting the second agency to join the affiliate network. In some example embodiments, in order to invite the second agency to join the affiliate network of the first agency certain criteria must be met. For example, the second agency may require a password, or other information to be entered. Other criteria which may be used to determine if an invite can be sent include the size, reputation or geographic location of the first agency.

Block 206 depicts a message being sent to the account of the second agency after the invite had been sent. The message may include a customizable message from the first agency. In some example embodiments, the message will only be viewable through the web based system. In other embodiments, the message will be sent as an email to one or more email accounts external to the system.

Decisional node 208 depicts whether the second agency accepts the invitation to join the first agency's affiliate network. The second agency may be presented with information about the first agency and be given an option to accept or decline. In some example embodiments, the second agency may be presented with an option to request more information from the first agency. The request for more information may include a customizable message to the first agency or may be a form response.

Block 210 depicts the first and second agencies being added to each others networks. In some example embodiments, this will allow the first and second agencies to view the jobs they have posted. In some example embodiments, adding the agencies to each other's network will update the profile information stored by the system. This information may be stored in any manner known or convenient. For example, the information could be stored in a file system or a database.

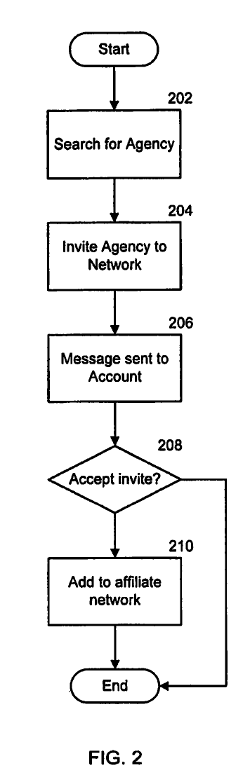

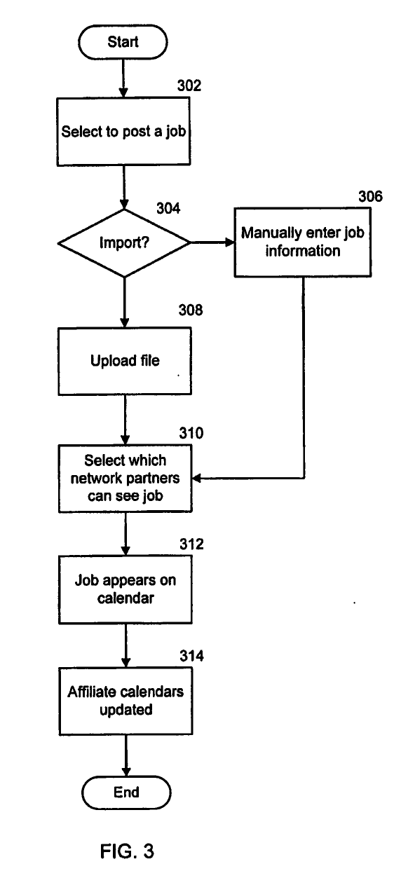

FIG. 3 depicts and example flowchart 300 of posting a job for other agencies. The flowchart 300 includes block 302, decisional node 304, block 306, block 308, block 310, block 312, and block 314.

Block 302 depicts selecting a post a job option. The selection may be made in any manner known or convenient. For example, the selection could be made through a graphical user interface on a webpage or a text command. In some example embodiments, the first agency must log-in to a website system using a name and password as validation.

Decisional node 304 depicts whether the user selects whether to import the job information in the form of a file including the job information or whether to enter the job information manually. For example, the selection could be made through a graphical user interface on a webpage or a text command.

Block 306 depicts entering the job information manually. Example information which may be entered includes information about the hiring party, the location of the job, the requesting agency, setting information, and any other information known or convenient. In some example embodiments, the job will be for a court reporting job. The job may include the case name, the law firms involved, who is being deposed, the language of the deposition, or any other information known or convenient. In some example embodiments, some information will only be displayed after the job has already been accepted by another agency. In some example embodiments, some of the information will be stored and entered automatically without manual entering.

Block 308 depicts uploading the job information in may be imported in the form of a file including the information. For example, a Reporterbase file may be used which includes the information. In some example embodiments, the file may not include all desired information and some information will be entered by manually.

Block 310 depicts selecting which affiliates will be offered the job. The affiliates may be presented by the geographic proximity to the job location. In some example embodiments, the order may be partially or completely dependent on how many jobs have been offered by the affiliate or how many of the jobs offered by the affiliate have been accepted. In some example embodiments, the option may be presented which allows all agencies in an area to view the job even if they are not affiliates of the agency posting the job. In some example embodiments, an affiliates may be divided into classes, each class subsequent class viewing the job after a set period of time has expired with no agency taking the job. For example, a first class of agencies could have a week to take a posted job. If the week expires the job could be offered to a second class of agencies. If a certain period of time passes without those agencies taking the job the job could be offered to more agencies or the public, if desired.

Block 312 depicts the new job appearing in the calendars of the posting agency. When the posting agency views their calendar on the system the calendar may now include the new job. The job may be given a specific color or other distinguishing aspect depending on the job's properties. In some example embodiments, the agency posting the job will have the job added to their calendar, and the job may be color coded based on being an out going job.

Block 314 depicts the new job appearing on the selected affiliate agencies calendars. When the affiliate agency views their calendar on the system the calendar may now include the new job. The job may be given a specific color or other distinguishing aspect depending on its properties. In some example embodiments, the affiliate agencies will have the have the job added their calendars, and the job may be a color coded based on being an in coming job.

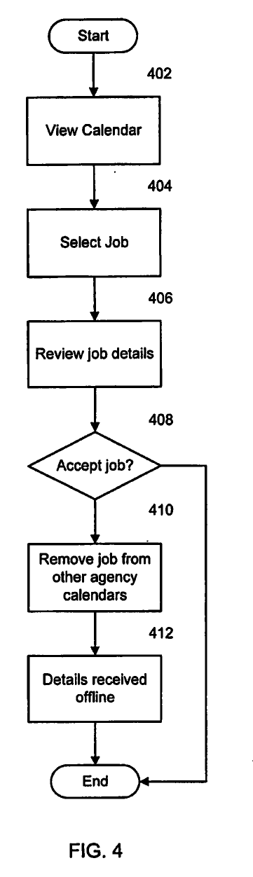

FIG. 4 depicts a flowchart 400 of accepting a job offered by an affiliate agency. The flowchart 400 includes block 402, block 404, block 406, decisional node 408, block 410, and block 412.

Block 402 depicts selecting to view an agency calendar. The calendar may be implemented in any manner known or convenient. The calendar may include all jobs accepted and offered by the agency. In some example embodiments, the type of job may be color coded or distinguished by another aspect known or convenient.

Block 404 depicts selecting a job on the calendar. The selection may be made in any manner known or convenient. For example, the job may be clicked on by a cursor.

Block 406 depicts reviewing the details of the job. The job details may include any information known or convenient. In some example embodiments, the job details will include which parties are involved, the hiring law firms, where the job will be located, the possible duration, any benefits, the languages to be spoken, the presence of a video recorder, etc. In some example embodiments, the job details will be the information collected as described in FIG. 3 for block 306.

Decisional node 408 depicts whether the agency accepts the offered job. In some example embodiments, the agency can reject the job offer and the job offer may no longer appear on the agency's calendar. Notice of the rejection of the job offer may be mailed to the offering agency.

Block 410 depicts removing the job from the calendars of other agencies the position was offered to.

Block 412 depicts the details of the position being reviewed offline. In some example embodiments, the accepting agency may contact the offering agencies for further details. Contact may be in any manner known or convenient. In some example embodiments, the details have already been entered and will be emailed to the accepting party after accepting.

In some example embodiments, the affiliate agency may set up parameters on the system to take jobs meeting the parameters automatically. For example, all jobs posted on certain days, or in a certain geographic area will be taken automatically. The number of jobs taken automatically can be limited to certain numbers and tracked by the system. In some example embodiments, the members of an agency will be assigned jobs automatically and will be sent a message indicating the members schedule for the week.

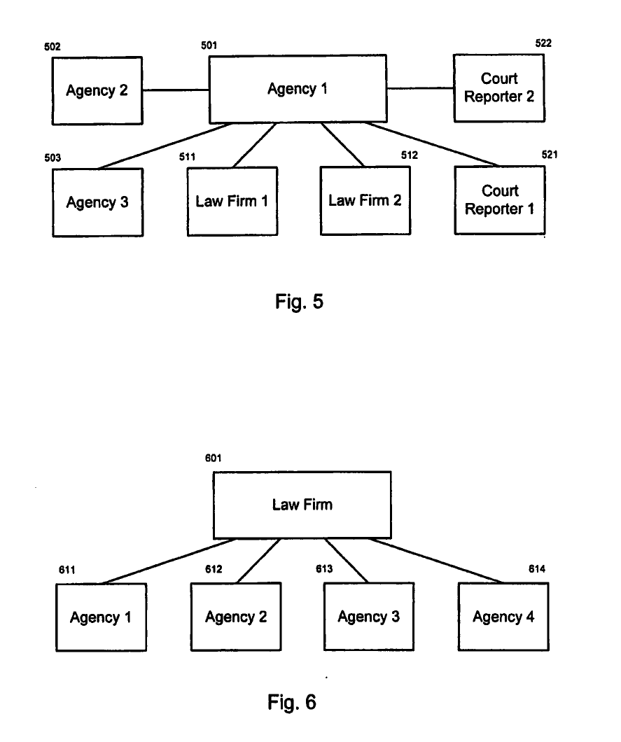

FIG. 5 depicts an example court reporting agency network 500. The network 500 includes a first agency 501, a second agency 502, a third agency 503, a first law firm 511, a second law firm 512, a first court reporter 521, and a second court reporter 522. The network 500 may represent agency 501's affiliate network in the stenographic job sharing network.

Agency 501's network has second agency 502 and third agency 503 as well as a first law firm 511, a second law firm 512, a first court reporter 521 and a second court reporter 522. Having law firms and court reporters in the network may allow the law firms to post directly to a court reporting agency, which in turn could fill jobs directly with either court reporters or with affiliate agencies.

Agency 501 may receive job postings from law firms 511 and 512, and from other agencies 502 and 503. The job postings may be filled with court report 521, court reporter 522, or through agency 502 or agency 503.

It will be appreciated that while only two affiliated agencies 502 and 503, two affiliated law firms 511 and 512 and two court reporters 521 and 522 are depicted, the agency 501 may be affiliated with any number of agencies, law firms, and court reporters.

FIG. 6 depicts a law firm—court reporting agency network 600. The network 600 includes law firm 601, first agency 611, a second agency 612, a third agency 613, and a fourth agency 614. The law firm 601 may post directly to agencies in the law firm 601's law firm—court reporting agency network 600. The network 600 may represent the law firm 691's affiliate network in the stenographic job sharing network.

Each agency in the network 600 may be affiliated with one or more court reporters and one or more affiliate agencies, as discussed above. A job posted by the law firm 601 may be filled by any of its affiliated agencies, or another affiliated agency. The law firm 601 may control which affiliated agencies may view its job posting.

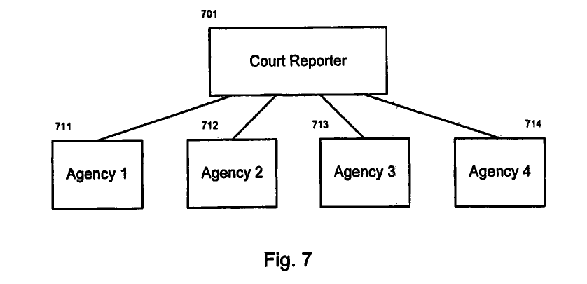

FIG. 7 depicts a court reporter—court reporting agency network 700. The network 700 includes court reporter 701, a first agency 711, a second agency 712, a third agency 713, and a fourth agency 714. The court reporter 701 may respond directly to agencies in the court reporter's 701's court reporter—court reporting agency network. The network 700 may represent the court reporter 701's affiliate network in the stenographic job sharing network.

Each agency in the network 700 may be affiliated with one or more law firms and one or more affiliate agencies, as discussed above. The court reporter 701 may accept a job from any of his affiliated agencies. The court reporter 701's view of available jobs may be limited to jobs in a specified geographical area. Job postings may be made by law firms or agencies, and may specify which court reporters may view the job posting.

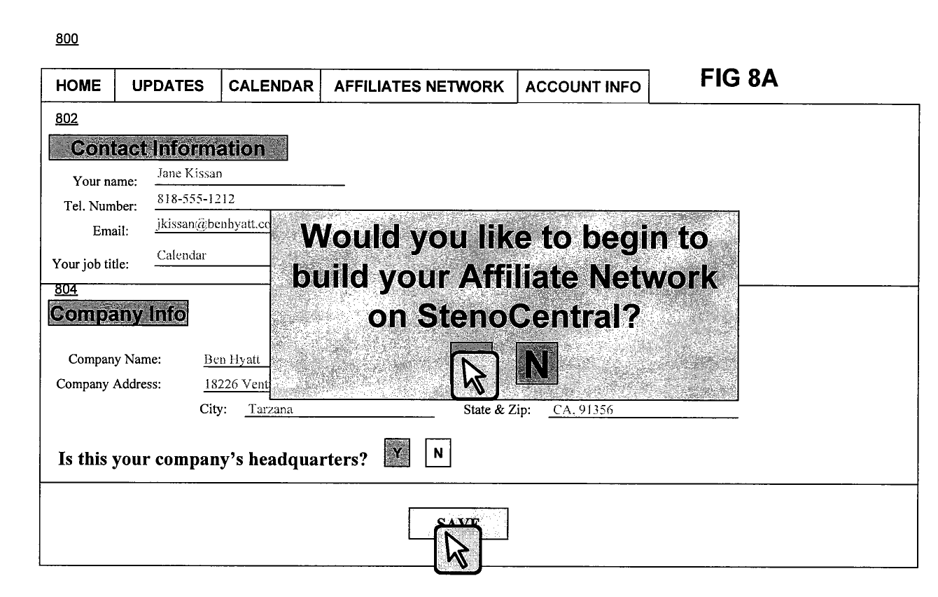

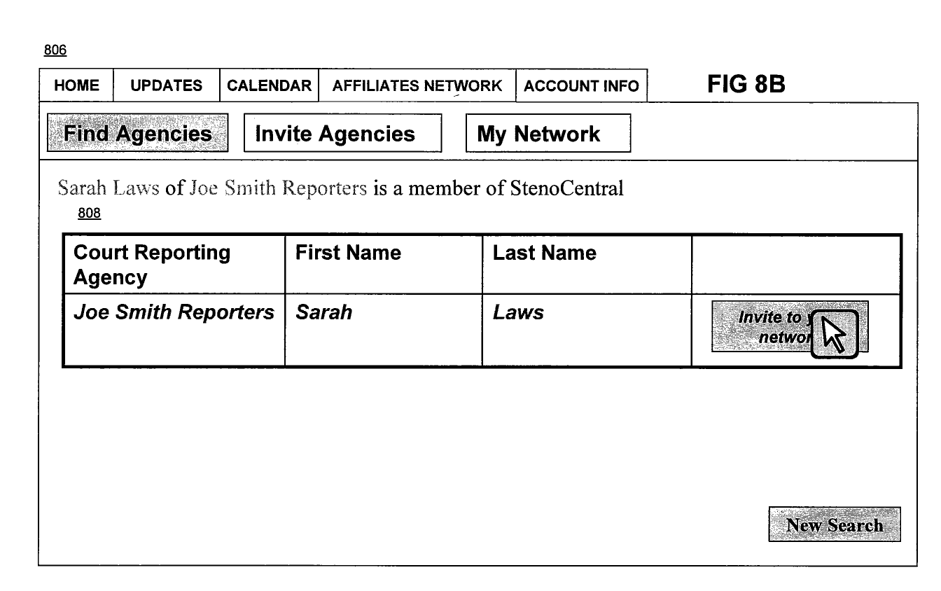

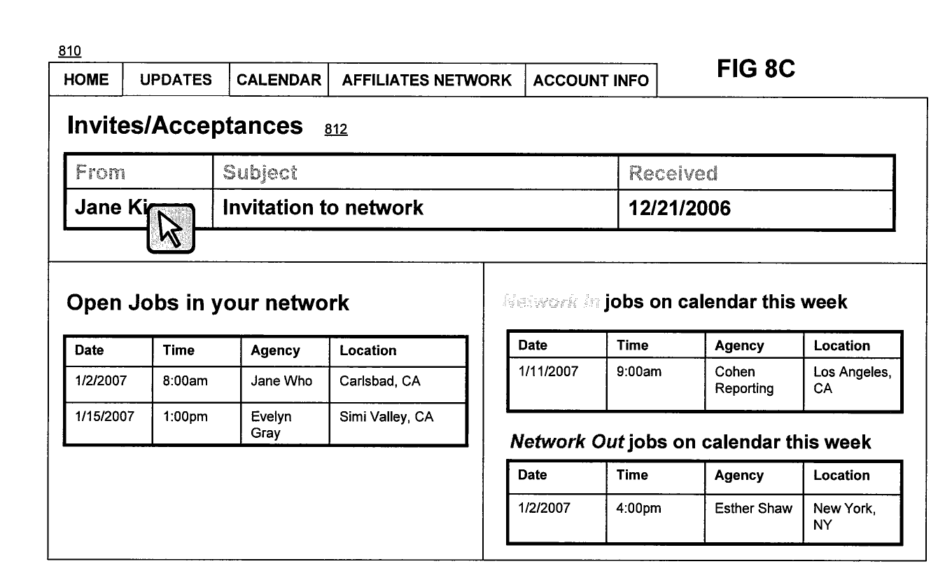

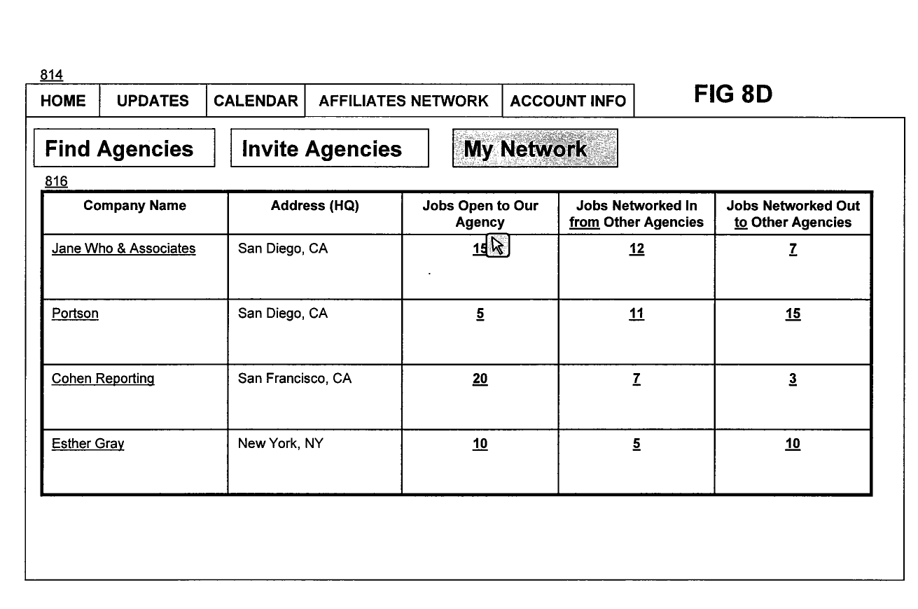

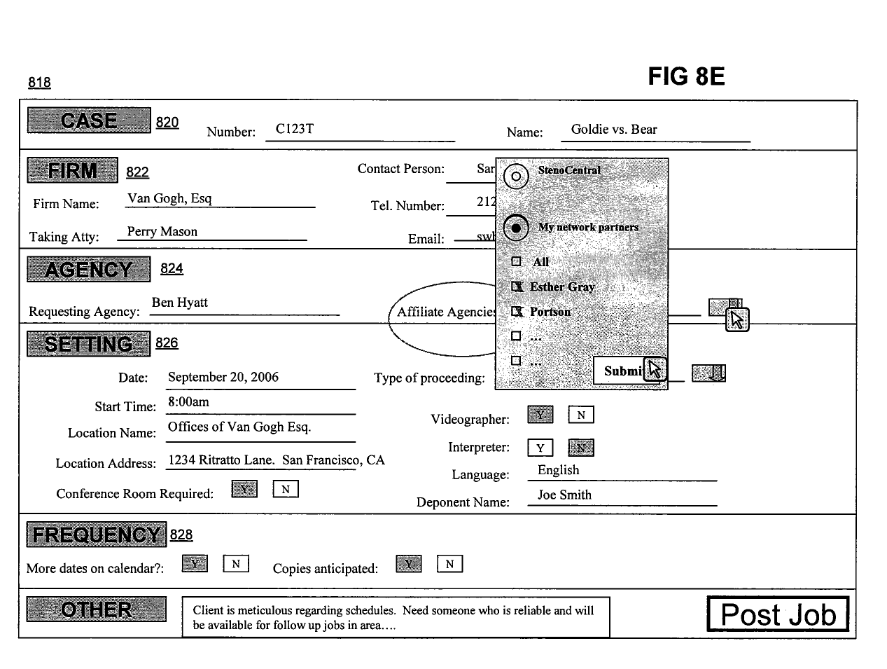

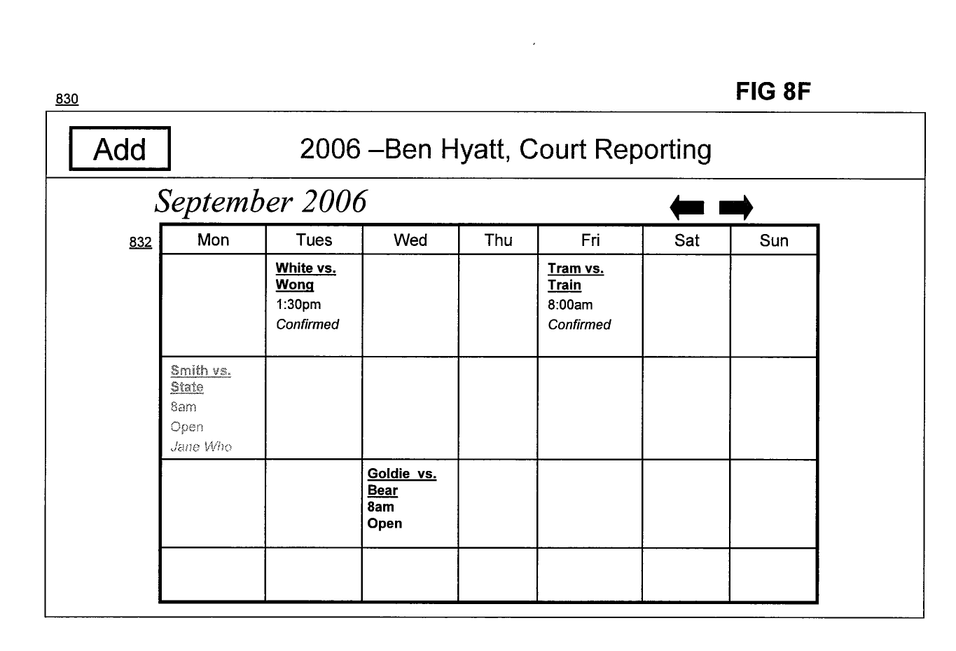

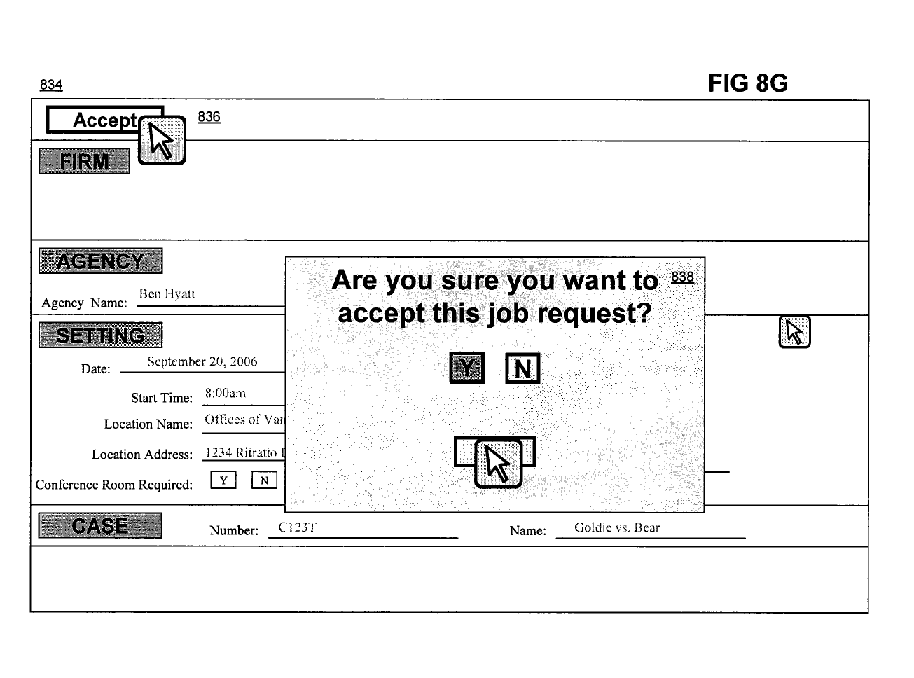

FIG. 8A depicts an example profile creation screen shot 800 in the stenographic sharing network. A user such as a court reporting agency may create a profile for use in the stenographic sharing network. The profile may include a contact person's information 802and company information 804. A contact person for example may be a court reporting agency owner or a ‘scheduler’ that works for the court reporting agency. A scheduler is responsible for managing a court reporting agency's calendar. A calendar may consist of various types of legal proceedings—including but not limited to depositions, disciplinary hearings, exams under oath, independent medicals exams, etc. The user may save a newly created profile, and thus create a new profile for use in the stenographic sharing network.

FIG. 8B depicts an example invitation screen shot 806 in the stenographic sharing network. After a user has created a profile and logged into the stenographic sharing network, the user may search for other court reporting agencies or court reporters also on the network. For example, the user may search for a court reporting agency employer (i.e. owner or scheduler) by a first name, a last name, a court reporting agency, or any combination of criteria. A search result 808 may be displayed if a profile in the system matches the search criteria. Once a matching profile has been found, she/he may be invited into the user's affiliate network.

If no profile has been found in the network matching the search criteria, the user may invite a non-network member to join the network by completing a form and sending an invitation email.

FIG. 8C depicts an example invitation/acceptance screen shot 810 in the stenographic sharing network. A user may create a profile in the network similar to the agency procedure discussed above. The user may log in to view any pending invitations 812 to join another's affiliate network. From this screen, the user may accept pending invitations and thus join a court reporting agency's affiliate network.

The user may also refuse an invitation, or send an email requesting more information.

The screen shot 810 also displays open jobs available to the user, a calendar of accepted jobs from within the network, and a calendar of accepted jobs from outside the network.

FIG. 8D depicts an example affiliate network screen shot 814 in the stenographic sharing network. The screen shot 814 may display a list of affiliates 816 in the user's affiliate network and job histories and other information for each affiliate. For example, each affiliate may be a court reporting agency associated with a headquarters address. For each affiliate, a number of jobs available to the user's agency, jobs networked in from other agencies, and jobs networked out to other agencies may be displayed.

The user may view a list of available jobs from each affiliate by clicking on the table entires. The user may also view job details from the list of available jobs.

FIG. 8E depicts an example job posting submission screen shot 818 in the stenographic sharing network. A job posting may include case information 820, firm information 822, agency information 824, job details 826, job frequency 828, and any other relevant information. The user may specify which affiliate within the user affiliate network may view and accept the job posting.

In an alternative, the user may also import job information from a third-party software. The user will be given the opportunity to enter any metadata, such as which affiliates may view the job posting.

The user may be asked whether the affiliate should take care of ancillary needs, such as reserving a conference room or arranging for a videographer.

FIG. 8F depicts an example user calendar screen shot 830 in the stenographic sharing network. A calendar 832 may be displayed to the user, containing relevant jobs.

For example, a court reporting agency may see its pending jobs from its affiliates and law firms and whether the jobs have been accepted by a court reporter. A court reporter may see pending and accepted jobs from affiliated court reporting agencies. A law firm my see pending and accepted jobs for its court reporting sessions.

Affiliate agencies' calendars are updated responsive to newly inputted jobs from law firms or other court agencies. Court reporter calendars are also updated to reflect available and accepted jobs.

FIG. 8G depicts an example job acceptance screen shot 834 in the stenographic sharing network. A court reporter or a court reporting agency may view an accept job screen 836 to view job details and accept the job. For competitive reasons, the law firm information may be blocked out until the job has been accepted.

Once a job has been accepted, it is considered filled by the posting user. It will appear on both the posting and accepting users' calendar in the network. Further communications between the users may occur off the stenographic job sharing network.

One example embodiment is a system for providing a stenographic job sharing network. The system includes a communications network. The system includes a server in communication with at least one user over the communications network, the user associated with a user role selected from the set consisting of: a court reporting agency, a court reporter, and a law firm. The system is configured to provide a user interface to the stenographic job sharing network to the user. The system is configured to, responsive to user invitations and acceptances, build a user network of affiliates. The system is configured to display a user calendar of jobs, the user calendar dependant on the user's role and accepted jobs. Jobs viewable in the stenographic job sharing network may be limited by a user's geographic proximity. A posting user may specify who may view a job post. The posting user may submit associated reservation requests associated with the job post. The user network of affiliates may reflect vendors and clients of the user. The server is configured to receive a user-specified information from the user and create an associated user profile from the user-specified information. Job postings may be imported from a third-party software.

Another example embodiment may be a method for providing a stenographic job sharing network. The method may include providing a user interface to the stenographic job sharing network to a user, the user associated with a user role selected from the set consisting of: a court reporting agency, a court reporter, and a law firm. The method may include, responsive to user invitations and acceptances, building a user network of affiliates. The method may include displaying a user calendar of jobs, the user calendar dependant on the user's role and accepted jobs. Jobs viewable in the stenographic job sharing network may be limited by a user's geographic proximity. A posting user may specify who may view a job post. The posting user may submit associated reservation requests associated with the job post. The user network of affiliates may reflect vendors and clients of the user. The method may include receiving a user-specified information from the user and create an associated user profile from the user-specified information. Job postings may be imported from a third-party software.

Another example embodiment may be a computer-readable medium including instructions adapted to execute a method for providing a stenographic job sharing network. The method may include providing a user interface to the stenographic job sharing network to a user, the user associated with a user role selected from the set consisting of: a court reporting agency, a court reporter, and a law firm. The method may include, responsive to user invitations and acceptances, building a user network of affiliates. The method may include displaying a user calendar of jobs, the user calendar dependant on the user's role and accepted jobs. Jobs viewable in the stenographic job sharing network may be limited by a user's geographic proximity. A posting user may specify who may view a job post. The posting user may submit associated reservation requests associated with the job post. The user network of affiliates may reflect vendors and clients of the user. The method may include receiving a user-specified information from the user and create an associated user profile from the user-specified information. Job postings may be imported from a third-party software.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

We claim:

1. A system for providing a stenographic job sharing network, comprising:
a communications network; and
a server in communication with at least one user over the communications network, the user associated with a user role selected from the set consisting of: a court reporting agency, a court reporter, and a law firm, the server configured to,
provide a user interface to the stenographic job sharing network to the user,
responsive to user invitations and acceptances, build a user network of affiliates, and
display a user calendar of jobs, the user calendar dependant on the user's role and accepted jobs.

2. The system of claim 1, wherein jobs viewable in the stenographic job sharing network is limited by a user's geographic proximity.

3. The system of claim 1, wherein a posting user specifies who may view a job post.

4. The system of claim 3, wherein the posting user submits associated reservation requests associated with the job post.

5. The system of claim 1, wherein the user network of affiliates reflects vendors and clients of the user.

6. The system of claim 1, the server further configured to
receive a user-specified information from the user and create an associated user profile from the user-specified information.

7. The system of claim 1, wherein job postings are imported from a third-party software.

8. A method for providing a stenographic job sharing network, comprising:
providing a user interface to the stenographic job sharing network to a user, the user associated with a user role selected from the set consisting of: a court reporting agency, a court reporter, and a law firm;
responsive to user invitations and acceptances, building a user network of affiliates; and
displaying a user calendar of jobs, the user calendar dependant on the user's role and accepted jobs.

9. The method of claim 8, wherein jobs viewable in the stenographic job sharing network is limited by a user's geographic proximity.

10. The method of claim 8, wherein a posting user specifies who may view a job post.

11. The method of claim 10, wherein the posting user submits associated reservation requests associated with the job post.

12. The method of claim 8, wherein the user network of affiliates reflects vendors and clients of the user.

13. The method of claim 8, further comprising:
receiving a user-specified information from the user and create an associated user profile from the user-specified information.

14. The method of claim 8, wherein job postings are imported from a third-party software.

15. A computer-readable medium including instructions adapted to execute a method for providing a stenographic job sharing network, the method comprising:
providing a user interface to the stenographic job sharing network to a user, the user associated with a user role selected from the set consisting of: a court reporting agency, a court reporter, and a law firm;
responsive to user invitations and acceptances, building a user network of affiliates; and
displaying a user calendar of jobs, the user calendar dependant on the user's role and accepted jobs.

16. The medium of claim 15, wherein jobs viewable in the stenographic job sharing network is limited by a user's geographic proximity.

17. The medium of claim 15, wherein a posting user specifies who may view a job post and imports the job post from a third-party software.

18. The medium of claim 17, wherein the posting user submits associated reservation requests associated with the job post.

19. The medium of claim 15, wherein the user network of affiliates reflects vendors and clients of the user.

20. The medium of claim 15, the method further comprising:
receiving a user-specified information from the user and create an associated user profile from the user-specified information.
